(19) United States
(12) Patent Application Publication
(10) Pub. No.: US 2021/0201392 A1
(43) Pub. Date: Jul. 1, 2021

(54) AUCTION SYSTEM FOR AUGMENTED REALITY EXPERIENCES IN A MESSAGING SYSTEM

(71) Applicant: Snap Inc., Santa Monica, CA (US)

(72) Inventors: Nima Aghdaii, Los Angeles, CA (US); Riccardo Boscolo, Culver City, CA (US); Rodrigo B. Farnham, Los Angeles, CA (US); Jean Luo, Los Angeles, CA (US); Kevin Lee Penner, Culver City, CA (US); Vincent Sung, Los Angeles, CA (US)

(21) Appl. No.: 16/836,236

(22) Filed: Mar. 31, 2020

Related U.S. Application Data
(60) Provisional application No. 62/955,944, filed on Dec. 31, 2019.

(51) Int. Cl. G06Q 30/08; H04L 12/58; G06Q 30/02

(52) U.S. Cl. CPC G06Q 30/08; H04L 51/046; G06Q 30/0272; G06Q 30/0276; G06Q 30/0273; H04L 51/32

(57) ABSTRACT

The subject technology identifies a first augmented reality content generator from a first merchant and a second augmented reality content generator from a second merchant. The subject technology receives a first bid amount from the first merchant and a second bid amount from the second merchant. The subject technology determines a highest bid amount among the first bid amount and the second bid amount. The subject technology provides the first augmented reality content generator or the second augmented reality content generator to a client device based on the determined highest bid.

### PRIORITY CLAIM

This application claims the benefit of priority of U.S. Provisional Patent Application No. 62/955,944, filed Dec. 31, 2019, which is hereby incorporated by reference herein in its entirety for all purposes.

### BACKGROUND

With the increased use of digital images, affordability of portable computing devices, availability of increased capacity of digital storage media, and increased bandwidth and accessibility of network connections, digital images have become a part of the daily life for an increasing number of people.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a diagrammatic representation of a messaging client application, in accordance with some example embodiments.

FIG. 3 is a diagrammatic representation of a data structure as maintained in a database, in accordance with some example embodiments.

FIG. 4 is a diagrammatic representation of a message, in accordance with some example embodiments.

FIG. 5 is a block diagram illustrating various modules of an augmented reality content generator application, according to certain example embodiments.

FIG. 6 illustrates a user interface for selecting parameters of an online advertising campaign in the subject messaging system, according to some embodiments.

FIG. 7 illustrates a user interface for selecting a format of a set of advertisements in an online advertising campaign in the subject messaging system, according to some embodiments.

FIG. 8 illustrates a user interface for setting parameters related to bidding, according to some embodiments.

FIG. 9 illustrates an example statement representing a PID controller, in accordance with some embodiments.

FIG. 10 illustrates an example chart of a convergence graph for a constant scale factor, in accordance with some embodiments.

FIG. 11 illustrates an example chart with improved convergence after performing the operations based on a fluctuation factor, in accordance with some embodiments.

FIG. 12 illustrates example statements for determining a return on investment (ROI), in accordance with some embodiments.

FIG. 13 illustrates example statements for determining values of desired rates for impressions, in accordance with some embodiments.

FIG. 14 illustrates example statements for determining values of desired impressions, in accordance with some embodiments.

FIG. 15 illustrates example charts corresponding to rate and impression plots, in accordance with some embodiments.

FIG. 16 includes examples of determining a value of desired impressions at a current time, in accordance with some embodiments.

FIG. 17 includes examples of lag correction, in accordance with some embodiments.

FIG. 18 illustrates an example chart of an exponential adaptation, in accordance with some embodiments.

FIG. 19 is a flowchart illustrating a method to determine a highest bid in an auction based on a global pacing multiplier, according to certain example embodiments.

FIG. 20 is block diagram showing a software architecture within which the present disclosure may be implemented, in accordance with some example embodiments.

FIG. 21 is a diagrammatic representation of a machine, in the form of a computer system within which a set of instructions may be executed for causing the machine to perform any one or more of the methodologies discussed, in accordance with some example embodiments.

### DETAILED DESCRIPTION

Users with a range of interests from various locations can capture digital images of various subjects and make captured images available to others via networks, such as the Internet. To enhance users' experiences with digital images and provide various features, enabling computing devices to perform image processing operations on various objects and/or features captured in a wide range of changing conditions (e.g., changes in image scales, noises, lighting, movement, or geometric distortion) can be challenging and computationally intensive.

As mentioned above, with the increased use of digital images, affordability of portable computing devices, availability of increased capacity of digital storage media, and increased bandwidth and accessibility of network connections, digital images have become a part of the daily life for an increasing number of people. Users with a range of interests from various locations can capture digital images of various subjects and make captured images available to others via networks, such as the Internet. To enhance users' experiences with digital images and provide various features, enabling computing devices to perform image processing operations on various objects and/or features captured in a wide range of changing conditions (e.g., changes in image scales, noises, lighting, movement, or geometric distortion) can be challenging and computationally intensive. Embodiments described herein provide for an improved system for image processing during a post-capture stage of image data or media content.

Messaging systems are frequently utilized and are increasingly leveraged by users of mobile computing devices, in various settings, to provide different types of functionality in a convenient manner. As described herein, the subject messaging system comprises practical applications that provide improvements in rendering augmented reality content generators (e.g., providing augmented reality experiences) on media content (e.g., images, videos, and the like) in which a particular augmented reality content generator may be activated through an improved auction system that enables bidding mechanisms that are more advantageously tailored for specific requirements associated with online advertising campaigns of respective entities (e.g., merchants, companies, individuals, and the like).

As referred to herein, the phrase “augmented reality experience,” “augmented reality content item,” “augmented reality content generator” includes and/or refers to various image processing operations corresponding to an image modification, filter, LENSES, media overlay, transformation, and the like, as described further herein.

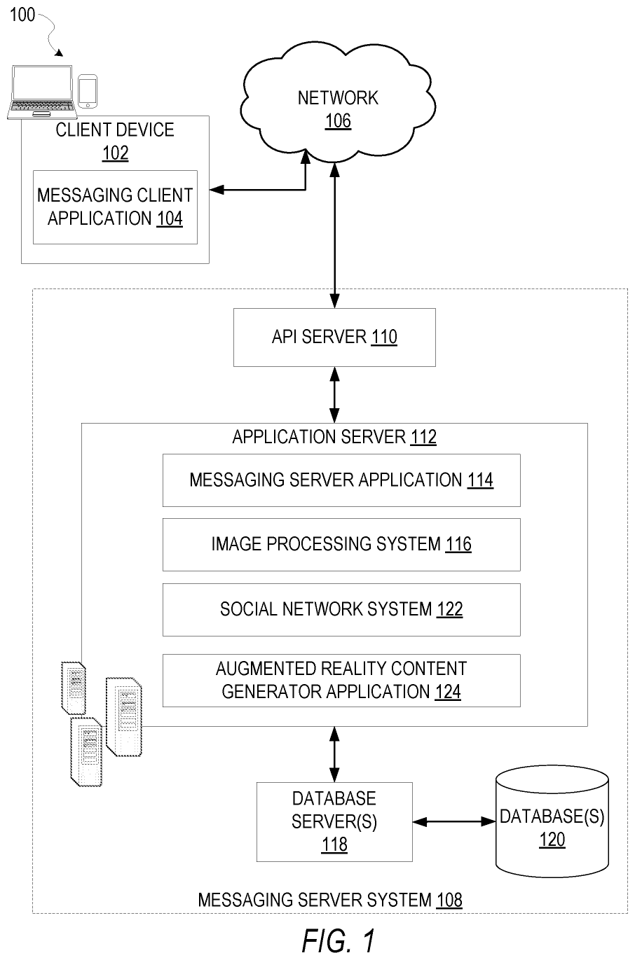

FIG. 1 is a block diagram showing an example of a messaging system 100 for exchanging data (e.g., messages and associated content) over a network. The messaging system 100 includes multiple instances of a client device 102, each of which hosts a number of applications including a messaging client application 104. Each messaging client application 104 is communicatively coupled to other instances of the messaging client application 104 and a messaging server system 108 via a network 106 (e.g., the Internet).

A messaging client application 104 is able to communicate and exchange data with another messaging client application 104 and with the messaging server system 108 via the network 106. The data exchanged between messaging client application 104, and between a messaging client application 104 and the messaging server system 108, includes functions (e.g., commands to invoke functions) as well as payload data (e.g., text, audio, video or other multimedia data).

The messaging server system 108 provides server-side functionality via the network 106 to a particular messaging client application 104. While certain functions of the messaging system 100 are described herein as being performed by either a messaging client application 104 or by the messaging server system 108, the location of certain functionality either within the messaging client application 104 or the messaging server system 108 is a design choice. For example, it may be technically preferable to initially deploy certain technology and functionality within the messaging server system 108, but to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. This data may include, message content, client device information, geolocation information, media annotation and overlays, message content persistence conditions, social network information, and live event information, as examples. Data exchanges within the messaging system 100 are invoked and controlled through functions available via user interfaces (UIs) of the messaging client application 104.

Turning now specifically to the messaging server system 108, an Application Program Interface (API) server 110 is coupled to, and provides a programmatic interface to, an application server 112. The application server 112 is communicatively coupled to a database server 118, which facilitates access to a database 120 in which is stored data associated with messages processed by the application server 112.

The Application Program Interface (API) server 110 receives and transmits message data (e.g., commands and message payloads) between the client device 102 and the application server 112. Specifically, the Application Program Interface (API) server 110 provides a set of interfaces (e.g., routines and protocols) that can be called or queried by the messaging client application 104 in order to invoke functionality of the application server 112. The Application Program Interface (API) server 110 exposes various functions supported by the application server 112, including account registration, login functionality, the sending of messages, via the application server 112, from a particular messaging client application 104 to another messaging client application 104, the sending of media files (e.g., images or video) from a messaging client application 104 to the messaging server application 114, and for possible access by another messaging client application 104, the setting of a collection of media data (e.g., story), the retrieval of a list of friends of a user of a client device 102, the retrieval of such collections, the retrieval of messages and content, the adding and deletion of friends to a social graph, the location of friends within a social graph, and opening an application event (e.g., relating to the messaging client application 104).

The application server 112 hosts a number of applications and subsystems, including a messaging server application 114, an image processing system 116, a social network system 122, and an augmented reality content generator application 124. The messaging server application 114 implements a number of message processing technologies and functions, particularly related to the aggregation and other processing of content (e.g., textual and multimedia content) included in messages received from multiple instances of the messaging client application 104. As will be described in further detail, the text and media content from multiple sources may be aggregated into collections of content (e.g., called stories or galleries). These collections are then made available, by the messaging server application 114, to the messaging client application 104. Other processor and memory intensive processing of data may also be performed server-side by the messaging server application 114, in view of the hardware requirements for such processing.

The application server 112 also includes an image processing system 116 that is dedicated to performing various image processing operations, typically with respect to images or video received within the payload of a message at the messaging server application 114.

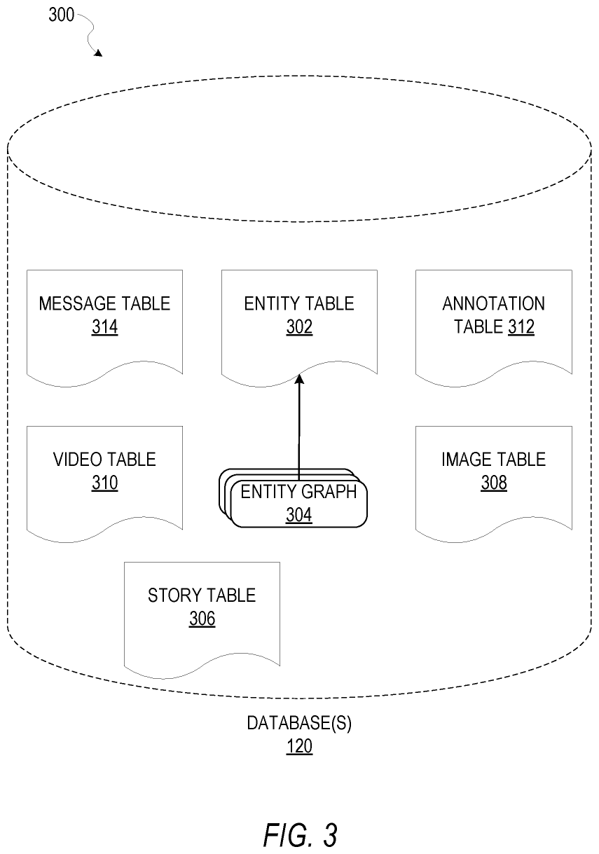

The social network system 122 supports various social networking functions services, and makes these functions and services available to the messaging server application 114. To this end, the social network system 122 maintains and accesses an entity graph 304 (as shown in FIG. 3) within the database 120. Examples of functions and services supported by the social network system 122 include the identification of other users of the messaging system 100 with which a particular user has relationships or is “following”, and also the identification of other entities and interests of a particular user.

The augmented reality content generator application 124 provides a system and a method for operating and publishing augmented reality content generators (e.g., providing augmented reality experiences) for messages processed by the messaging server application 114, particular with respect to online advertising campaigns and the auction system for augmented reality content generators described further herein. In an example, the augmented reality content generator application 124 supplies an augmented reality content generator to the client device 102 based on characteristics of media content (e.g., photograph or video, and the like) or a geolocation of the client device 102, among other types of signals (e.g., social network information from the social network system 122). Additionally, the augmented reality content generator application 124 includes a publication platform that enables merchants and/or other entities to select a particular augmented reality content generator via a bidding process. In an example, the augmented reality content generator application 124 associates a particular augmented reality content generator of a highest-bidding merchant or entity (e.g., company, individual, and the like) for inclusion in a message presented by the client device 102 based on one or more parameters as discussed further herein.

The application server 112 is communicatively coupled to a database server 118, which facilitates access to a database 120 in which is stored data associated with messages processed by the messaging server application 114.

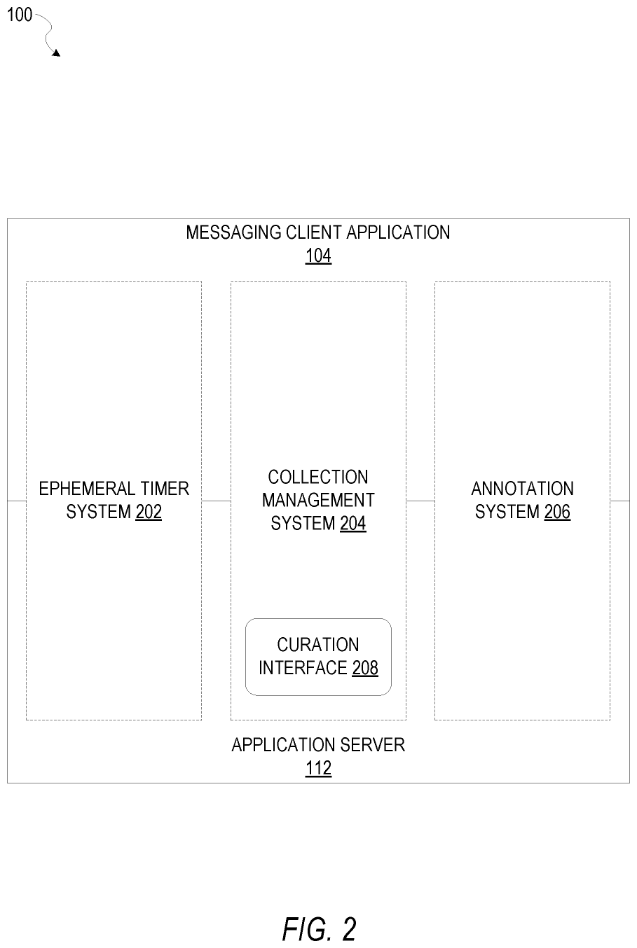

FIG. 2 is block diagram illustrating further details regarding the messaging system 100, according to example embodiments. Specifically, the messaging system 100 is shown to comprise the messaging client application 104 and the application server 112, which in turn embody a number of some subsystems, namely an ephemeral timer system 202, a collection management system 204 and an annotation system 206.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message, or collection of messages (e.g., a story), selectively display and enable access to messages and associated content via the messaging client application 104. Further details regarding the operation of the ephemeral timer system 202 are provided below.

The collection management system 204 is responsible for managing collections of media (e.g., collections of text, image video and audio data). In some examples, a collection of content (e.g., messages, including images, video, text and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user-generated content into a collection. In such cases, the curation interface 208 operates to automatically make payments to such users for the use of their content.

The annotation system 206 provides various functions that enable a user to annotate or otherwise modify or edit media content associated with a message. For example, the annotation system 206 provides functions related to the generation and publishing of augmented reality content generators (e.g., providing augmented reality experiences) for messages processed by the messaging system 100. The annotation system 206 operatively supplies an augmented reality content generator or supplementation (e.g., an image filter) to the messaging client application 104 based on a geolocation of the client device 102. In another example, the annotation system 206 operatively supplies an augmented reality content generator to the messaging client application 104 based on other information, such as social network information of the user of the client device 102. An augmented reality content generator may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 102. For example, the augmented reality content generator may include text that can be overlaid on top of a photograph taken by the client device 102. In another example, the augmented reality content generator includes an identification of a location overlay (e.g., Venice beach), a name of a live event, or a name of a merchant overlay (e.g., Beach Coffee House). In another example, the annotation system 206 uses the geolocation of the client device 102 to identify an augmented reality content generator that includes the name of a merchant at the geolocation of the client device 102. The augmented reality content generator may include other indicia associated with the merchant. The augmented reality content generators may be stored in the database 120 and accessed through the database server 118.

In one example embodiment, the annotation system 206 provides a user-based publication platform that enables users to select a geolocation on a map, and upload content associated with the selected geolocation. The user may also specify circumstances under which a particular augmented reality content generator (e.g., providing an augmented reality experience) should be offered to other users. The annotation system 206 generates an augmented reality content generator that includes the uploaded content and associates the uploaded content with the selected geolocation.

In another example embodiment, the annotation system 206 provides a merchant-based publication platform that enables merchants to select a particular augmented reality content generator associated with a geolocation via a bidding process. For example, the annotation system 206 associates the augmented reality content generator of a highest bidding merchant with a corresponding geolocation for a predefined amount of time.

FIG. 3 is a schematic diagram illustrating data structures 300 which may be stored in the database 120 of the messaging server system 108, according to certain example embodiments. While the content of the database 120 is shown to comprise a number of tables, it will be appreciated that the data could be stored in other types of data structures (e.g., as an object-oriented database).

The database 120 includes message data stored within a message table 314. The entity table 302 stores entity data, including an entity graph 304. Entities for which records are maintained within the entity table 302 may include individuals, corporate entities, organizations, objects, places, events, etc. Regardless of type, any entity regarding which the messaging server system 108 stores data may be a recognized entity. Each entity is provided with a unique identifier, as well as an entity type identifier (not shown).

The entity graph 304 furthermore stores information regarding relationships and associations between entities. Such relationships may be social, professional (e.g., work at a common corporation or organization) interested-based or activity-based, merely for example.

The database 120 also stores annotation data, in the example form of filters, in an annotation table 312. Filters for which data is stored within the annotation table 312 are associated with and applied to videos (for which data is stored in a video table 310) and/or images (for which data is stored in an image table 308). Filters, in one example, are overlays that are displayed as overlaid on an image or video during presentation to a recipient user. Filters may be of varies types, including user-selected filters from a gallery of filters presented to a sending user by the messaging client application 104 when the sending user is composing a message. Other types of filters include geolocation filters (also known as geo-filters) which may be presented to a sending user based on geographic location. For example, geolocation filters specific to a neighborhood or special location may be presented within a user interface by the messaging client application 104, based on geolocation information determined by a GPS unit of the client device 102. Another type of filer is a data filer, which may be selectively presented to a sending user by the messaging client application 104, based on other inputs or information gathered by the client device 102 during the message creation process. Example of data filters include current temperature at a specific location, a current speed at which a sending user is traveling, battery life for a client device 102, or the current time.

Other annotation data that may be stored within the image table 308 is data corresponding to an augmented reality content generator (e.g., providing an augmented reality experience). One example of an augmented reality content generator is a real-time special effect and sound that may be added to an image or video

As mentioned above, the video table 310 stores video data which, in one embodiment, is associated with messages for which records are maintained within the message table 314. Similarly, the image table 308 stores image data associated with messages for which message data is stored in the entity table 302. The entity table 302 may associate various annotations from the annotation table 312 with various images and videos stored in the image table 308 and the video table 310.

A story table 306 stores data regarding collections of messages and associated image, video, or audio data, which are compiled into a collection (e.g., a story or a gallery). The creation of a particular collection may be initiated by a particular user (e.g., each user for which a record is maintained in the entity table 302). A user may create a “personal story” in the form of a collection of content that has been created and sent/broadcast by that user. To this end, the user interface of the messaging client application 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from varies locations and events. Users whose client devices have location services enabled and are at a common location event at a particular time may, for example, be presented with an option, via a user interface of the messaging client application 104, to contribute content to a particular live story. The live story may be identified to the user by the messaging client application 104, based on his or her location. The end result is a “live story” told from a community perspective.

A further type of content collection is known as a “location story”, which enables a user whose client device 102 is located within a specific geographic location (e.g., on a college or university campus) to contribute to a particular collection. In some embodiments, a contribution to a location story may require a second degree of authentication to verify that the end user belongs to a specific organization or other entity (e.g., is a student on the university campus).

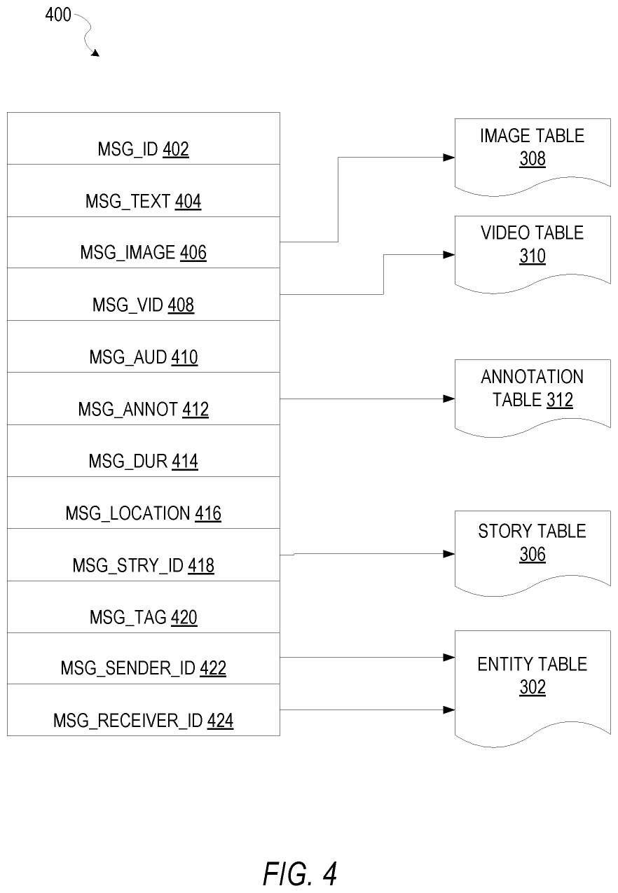

FIG. 4 is a schematic diagram illustrating a structure of a message 400, according to some embodiments, generated by a messaging client application 104 for communication to a further messaging client application 104 or the messaging server application 114. The content of a particular message 400 is used to populate the message table 314 stored within the database 120, accessible by the messaging server application 114. Similarly, the content of a message 400 is stored in memory as “in-transit” or “in-flight” data of the client device 102 or the application server 112. The message 400 is shown to include the following components:
A message identifier 402: a unique identifier that identifies the message 400.
A message text payload 404: text, to be generated by a user via a user interface of the client device 102 and that is included in the message 400.
A message image payload 406: image data, captured by a camera component of a client device 102 or retrieved from a memory component of a client device 102, and that is included in the message 400.
A message video payload 408: video data, captured by a camera component or retrieved from a memory component of the client device 102 and that is included in the message 400.
A message audio payload 410: audio data, captured by a microphone or retrieved from a memory component of the client device 102, and that is included in the message 400.
A message annotations 412: annotation data (e.g., filters, stickers or other enhancements) that represents annotations to be applied to message image payload 406, message video payload 408, or message audio payload 410 of the message 400.
A message duration parameter 414: parameter value indicating, in seconds, the amount of time for which content of the message (e.g., the message image payload 406, message video payload 408, message audio payload 410) is to be presented or made accessible to a user via the messaging client application 104.
A message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image into within the message image payload 406, or a specific video in the message video payload 408).
A message story identifier 418: identifier values identifying one or more content collections (e.g., “stories”) with which a particular content item in the message image payload 406 of the message 400 is associated. For example, multiple images within the message image payload 406 may each be associated with multiple content collections using identifier values.
A message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
A message sender identifier 422: an identifier (e.g., a messaging system identifier, email address, or device identifier) indicative of a user of the client device 102 on which the message 400 was generated and from which the message 400 was sent
A message receiver identifier 424: an identifier (e.g., a messaging system identifier, email address, or device identifier) indicative of a user of the client device 102 to which the message 400 is addressed.

The contents (e.g., values) of the various components of message 400 may be pointers to locations in tables within which content data values are stored. For example, an image value in the message image payload 406 may be a pointer to (or address of) a location within an image table 308. Similarly, values within the message video payload 408 may point to data stored within a video table 310, values stored within the message annotations 412 may point to data stored in an annotation table 312, values stored within the message story identifier 418 may point to data stored in a story table 306, and values stored within the message sender identifier 422 and the message receiver identifier 424 may point to user records stored within an entity table 302.

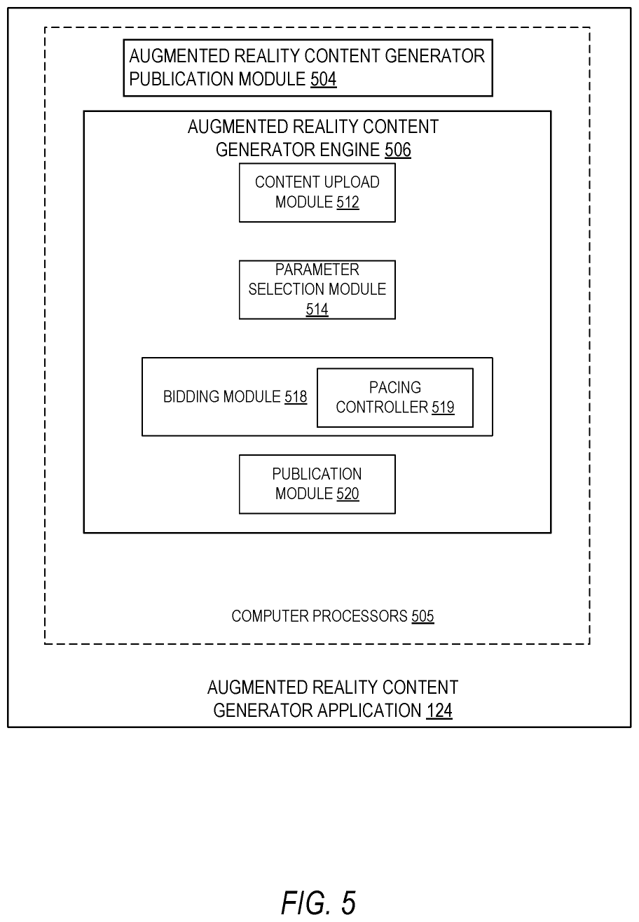

FIG. 5 is a block diagram illustrating various modules of an augmented reality content generator application (e.g., the augmented reality content generator application 124), according to certain example embodiments.

The augmented reality content generator application 124 is shown as including an augmented reality content generator publication module 504, and an augmented reality content generator engine 506 (which includes several components as discussed further below). The various modules of the augmented reality content generator application 124 are configured to communicate with each other (e.g., via a bus, shared memory, or a switch). Any one or more of these modules may be implemented using one or more computer processors 505 (e.g., by configuring such one or more computer processors to perform functions described for that module) and hence may include one or more of the computer processors 505 (e.g., a set of processors provided by the messaging server system 108 and/or the application server 112). In another embodiment, the computer processors 505 refers to a set of processors provided by a client device, such as the client device 102.

Any one or more of the modules described may be implemented using hardware alone (e.g., one or more of the computer processors 505 of a machine (e.g., machine 2400) or a combination of hardware and software. For example, any described module of the augmented reality content generator application 124 may physically include an arrangement of one or more of the computer processors 505 (e.g., a subset of or among the one or more computer processors of the machine (e.g., machine 2400) configured to perform the operations described herein for that module. As another example, any module of the augmented reality content generator application 124 may include software, hardware, or both, that configure an arrangement of one or more computer processors 505 (e.g., among the one or more computer processors of the machine (e.g., machine 2400) to perform the operations described herein for that module. Accordingly, different modules of the augmented reality content generator application 124 may include and configure different arrangements of such computer processors 505 or a single arrangement of such computer processors 505 at different points in time. Moreover, any two or more modules of the augmented reality content generator application 124 may be combined into a single module, and the functions described herein for a single module may be subdivided among multiple modules. Furthermore, according to various example embodiments, modules described herein as being implemented within a single machine, database, or device may be distributed across multiple machines, databases, or devices.

The augmented reality content generator publication module 504 provides a platform for publication of augmented reality content generators. The augmented reality content generator publication module 504 enables merchants and/or other entities to upload content, select various parameters corresponding to a particular online advertising campaign, and submit a bid amount for an augmented reality content generator(s).

The augmented reality content generator engine 506 generates and supplies an augmented reality content generator (e.g., providing an augmented reality experience) based on different signals (e.g., geolocation, contextual information, social networking information, and the like) of a given client device (e.g., the client device 102). The augmented reality content generator may be based on predefined augmented reality content generators, user-based augmented reality content generators, or merchant-based augmented reality content generators.

The following discussion describes examples of predefined augmented reality content generators (e.g., generated by the messaging server system 108 either programmatically and/or included as a default set of augmented reality content generators utilized throughout the subject messaging system). A predefined augmented reality content generator (e.g., providing an augmented reality experience) can include an augmented reality content generator based on live event information. The live event information may be related to a live game score of a sporting event associated with a corresponding geolocation, or a live news event related to an entertainment (e.g., concert) or social event associated with a corresponding geolocation. Another example includes an augmented reality content generator based on social network information of a user of the client device 102. The social network information may include social network data retrieved from a social network service provider (e.g., the social network system 122). In an example, the social network data may include profile data of the user, “likes” of the user, establishments that the user follows, friends of the user, and postings of the user, among others. Another example includes augmented reality content generators for a promotion (e.g., a game, contest, lottery). For example, a set of unique augmented reality content generators may be generated. One augmented reality content generator from the set of unique augmented reality content generators may be provided to the client device 102 when the client device 102 is at a predefined location associated with the augmented reality content generators or when an object (e.g., name, logo, product, etc.) is recognized in a photograph or video taken by the user.

Further, the aforementioned user-based augmented reality content generators (e.g., providing augmented reality experiences) are created by users, and the merchant-based augmented reality content generators are created by merchants and/or other entities. In some embodiments, such user-based and/or merchant-based augmented reality content generators can include similar characteristics and/or behavior to those discussed above in connection with predefined augmented reality content generators.

As shown, the augmented reality content generator engine 506 includes a content upload module 512, a parameter selection module 514, a bidding module 518, and a publication module 520.

In an example, the content upload module 512 receives content from a merchant. The content may include media content such as a picture, a video, a graphic, or a text. In an embodiment, the content upload module 512 is implemented on a web server (e.g., provided by the application server 112 and/or messaging server system 108) to allow a merchant to upload the content using a webpage or web-based interface.

In an embodiment, the parameter selection module 514 receives one or more selections of parameters associated with a given online advertising campaign (e.g., where advertisements are served via electronic means), which is determined and configured by the merchant. For example, the parameter selection module 514 receives geolocation identification information from the merchant to identify a particular geolocation. The geolocation identification information may include an address of an establishment, an identification of an establishment already associated with the address, GPS coordinates, or a geographic boundary, and the like. In another example, the parameter selection module 514 receives, from the merchant, time duration information related to the uploaded content. The time duration may identify a period of time in which the uploaded content is associated with the particular geolocation. Other embodiments include periodic time duration information or specific time duration information. Further, in an example, the parameter selection module 514 receives information corresponding to target criteria for the online advertising campaign, which may include country, city, geographic region, education, income, age, gender, parental status, pet owner status, interests, online activity, spoken language, serviceable addressable market, device operating system, device manufacturer, carrier or telecommunications service, and the like. In another example, the parameter selection module 514 receives information indicating a budget (e.g., daily budget or lifetime budget of the online advertising campaign), pacing (e.g., standard or accelerated) of bidding, optimization goal(s), billing event(s), bidding strategies (e.g., maximum bid, auto bidding, etc.), type of augmented reality content generator, and the like. In an example, pacing information can include a number of impressions to win in a given period of time.

In an embodiment, the bidding module 518 provides an interface to enable merchants to submit a bid amount for an impression associated with an augmented reality content generator based at least in part on the aforementioned parameters. In an example, the bidding module 518 identifies a highest bidder and awards the highest bidder with the ability to exclude other merchant-based augmented reality content generators for a particular amount of time. In an embodiment, the bidding module 518 may utilize second price auction techniques where the highest bidder pays the price of the second highest bid (as discussed further herein) for an impression associated with an augmented reality content generator. Further, the bidding module 518 implements pacing of bidding by a given merchant based on the aforementioned parameters.

As further shown, the bidding module 518 includes a pacing controller 519. The pacing controller 519, in some embodiments, controls a rate (e.g., “pace”) of bidding by a given merchant based on a pacing multiplier which can increase or decrease respective instances of bidding. Embodiments of the pacing multiplier are discussed further below.

The publication module 520 generates an augmented reality content generator (e.g., providing am augmented reality experience) that associates the uploaded content of the highest bidder to the augmented reality content generator. The publication module 520 publishes the augmented reality content generator to a set of client devices based on the aforementioned parameters selected by the highest bidder. In an example, other augmented reality content generators from other merchants that may satisfy the advertising campaign parameters are excluded from publication to the set of client devices. In another embodiment, a limit may be placed on the number of augmented reality content generators available. For example, the publication module 520 may publish and make available a limited number of augmented reality content generators (e.g., a maximum of two augmented reality content generators) to the set of client devices.

In another example embodiment, the publication module 520 forms a priority relationship that associates the uploaded content of the highest bidder. For example, an order in which augmented reality content generators are displayed at the client device 102 may be manipulated based on the results from the bidding module 508. An augmented reality content generator of a merchant with the highest bid may be prioritized and displayed first at the client device 102. Augmented reality content generators from other merchants may be displayed at the client device 102 after the augmented reality content generator of the highest bidder.

In an example embodiment, an augmented reality content generator may be presented to a user automatically upon detection of a particular event. For example, when a user initiates taking (or has taken) a photograph or video, content in the photograph or video (e.g., audio, an object, a location, etc.) can trigger a set of augmented reality content generators to be displayed to the user for selection. Third party entities (e.g., merchants, companies, businesses, shops, individuals, etc.) can therefore submit bids (or otherwise purchase opportunities) to have, by utilizing the auction system described herein, overlays included in the set that is presented for user selection for augmentation and/or modification of media content (e.g., image, video, audio, and the like).

As discussed herein, various implementations of the augmented reality content generator application 124 are described. As discussed before, in an implementation, the augmented reality content generator application 124 executes at a server (e.g., the messaging server system 108) and generates augmented reality content generators that include and/or generate content based on different signals including, for example, geographic locations (also referred to as geolocations) and other contextual information (e.g., characteristics of an object recognized in captured image data and/or media content), social networking information, and the like. Other media enhancements or augmentations may include audio and visual content or visual effects that may be applied to augment a content or media item (e.g., image or video) at a client device (e.g., the client device 102). In an embodiment, the augmented reality content generator application 124 includes a publication platform, which is described further below.

As referred to herein, an “auction” is a process of buying and selling goods or services by offering them up for bid, taking bids, and then selling the item to the highest bidder. In auction-based advertising systems, advertisements (or “ads”) from different advertisers participate in an auction and the advertisement with the highest bid wins the auction and will be shown to the user.

As described herein, the bidding module 518 may utilize techniques to implement a second price auction. In an example, a second-price auction is a sealed-bid auction (e.g., the bidders do not know about other bids), and where the winner pays the price of the second highest bid. For example, for a second price auction with 3 bidders A, B, and C:
A: $1
B: $2
C: $3

In the above second price auction, the winner is C, and C will pay $2 corresponding to the second highest bid of $2 submitted by B. By utilizing second-price auction techniques, the bidding module 518 advantageously incentivizes bidders to bid their true value, which has been mathematically proven to correspond to a Nash Equilibrium. In game theory, the Nash equilibrium is a proposed solution of a non-cooperative game involving two or more players (e.g., respective bidders in the context of an auction) in which each player is assumed to know the equilibrium strategies of the other players, and no player has anything to gain by changing only their own strategy. Thus, if each player has chosen a strategy, and no player can benefit by changing strategies while the other players keep theirs unchanged, then the current set of strategy choices and their corresponding payoffs constitutes a “Nash” equilibrium. Some properties of this equilibrium include the following advantages/improvements:
Uses weakly dominant strategies: a strategy is weakly dominant if, regardless of what other players do, the strategy earns a player a payoff at least as high as any other strategy, and, the strategy earns a strictly higher payoff for some profile of other players' strategies
Strategy proof: agnostic to other players' strategy
Honest: incentivizes truthful bidding
Works with incomplete information: in the case of a sealed-bid auction where there is limited or no information about others' bid, strategy, etc.

In the aforementioned publication platform, the augmented reality content generator application 124 may provide various user interfaces for merchants to upload content (e.g., advertisement content, media content, etc.), select various options, and submit bids in an auction for augmented reality content generator(s) based on the selected option(s). A bidding process may determine the merchant with a highest bid amount corresponding to a winning bid based on a particular type of auction mechanism (e.g., second price auction). The winning merchant, via the augmented reality content generator application 124, may then exclude publication of augmented reality content generators from other merchants based on the selected option(s). Therefore, in an example, the augmented reality content generator of the highest-bidding merchant may be the sole augmented reality content generator that can be accessed by one or more client devices based on the selected option(s).

In some instances, merchants are enabled to purchase large, “guaranteed” type buys for augmented reality content generators. Such merchants did not want to invest resources (e.g., monetary and/or labor) in developing augmented reality content generators while not being able to reach users due to low bids for an auction.

However, as augmented reality content generators (e.g., LENSES, filters, overlays, and the like) have been utilized more in a self-serve advertising platform and production costs have been reduced, merchants (e.g., advertisers) may instead prefer to opt for non-guaranteed buying of augmented reality content generators for advertising. This enables merchants and other entities more flexibility around budgeting, targeting, start times, etc., which are relatively locked down for buy models for advertisements such as reach and frequency (e.g., “R&F”). In a reach and frequency model, advertisements are presented in accordance with a particular audience (“reach”), for a particular number of presentations or impressions (“frequency”) and for a particular duration (“time”) within a particular scheduled time window.

In an example, a non-guaranteed buy as described herein refers to a purchase of an inventory of advertisements (e.g., sold on an impression basis) through the subject auction system via real-time bidding. In this manner, an auction occurs between several merchants that bid for each individual impression in real-time, therefore, the inventory is considered “non-guaranteed” and the highest bidder will win the impression.

In embodiments described herein, the subject system (e.g., the augmented reality content generator application 124) enables configuring the pacing of bidding, in an auction that accepts real-time bidding, for impressions in an online advertising campaign. In an example, a bidding pace of an online advertisement campaign is determined based on a number of impressions won for a given period of time. One example objective of the online advertising campaign is to win a particular number of bids to meet a quota for impressions, where a bidding pace is adjusted to affect the number of bids won in order to satisfy the quota.

As an illustration, a merchant wants to advertise an advertisement (e.g., associated with content in an augmented reality content generator) over a time period of a week to get 100 K number of impressions. If the subject system presents the merchant's advertisement to users any time when targeting criteria of the advertisement matches, it is likely that the quota for impressions would be exhausted in the first few hours of the campaign. This behavior therefore makes the auction “bursty”, which results in a large number of advertisements being served thereby making the auction competitive and expensive while at a subsequent time period there is no advertisements that are left to present to users. In addition, advertisers may want their advertisement to be delivered throughout the lifetime of the campaign, not only the first few hours. Also, it is preferable to not overwhelm users with a large number of advertisements during a short period of time, while not presenting advertisements at a subsequent time still during the lifetime of the campaign. While frequency caps can assist with the user experience, it is more advantageous to present advertisement more evenly throughout the lifetime of the campaign, and therefore provide more opportunities than impressions to sell. Finally, it may be beneficial for advertisement delivery to deliver the impressions as efficiently and judiciously as possible, rather than spending the entire budget of the campaign within a few hours. In an example, simple solutions to the aforementioned issues can include splitting the budget into per hour or per minute budget. While such solutions may slightly improve the situation, the burstiness issue is not adequately resolves as these solution can convert one burst into smaller bursts.

The aforementioned issues can be addressed by the improved pacing techniques described in the following discussion below. More specifically, embodiments of the subject technology provide a proportional integral derivative controller, which employs a closed-loop control system, for addressing the aforementioned issues and to address burstiness of serving advertisements.

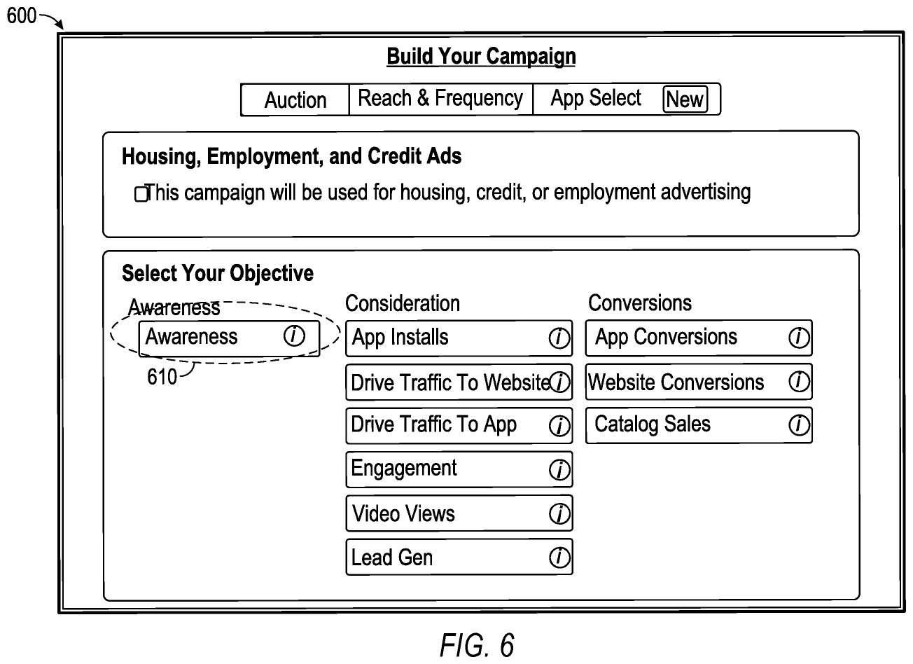

FIG. 6 illustrates a user interface 600 for selecting parameters of an online advertising campaign in the subject messaging system, according to some embodiments. In an embodiment, the user interface 600 is provided by the augmented reality content generator application 124 and/or the messaging server system 108, and accessible by the client device 102 to present to a user on a display screen of the client device 102.

As shown, the user interface 600 includes various parameters (e.g., options) corresponding to respective graphical elements for selecting an objective of an online adverting campaign. Examples of an objective can include awareness, application installs, increasing traffic to website, increasing traffic to an application, engagement, video views, lead generation, application conversions, website conversions, and/or catalog sales, and the like. In an example, the user can select one or more of the aforementioned objectives using the user interface 600. As illustrated, the user has selected a graphical element 610 to select awareness as being an objective of the advertising campaign.

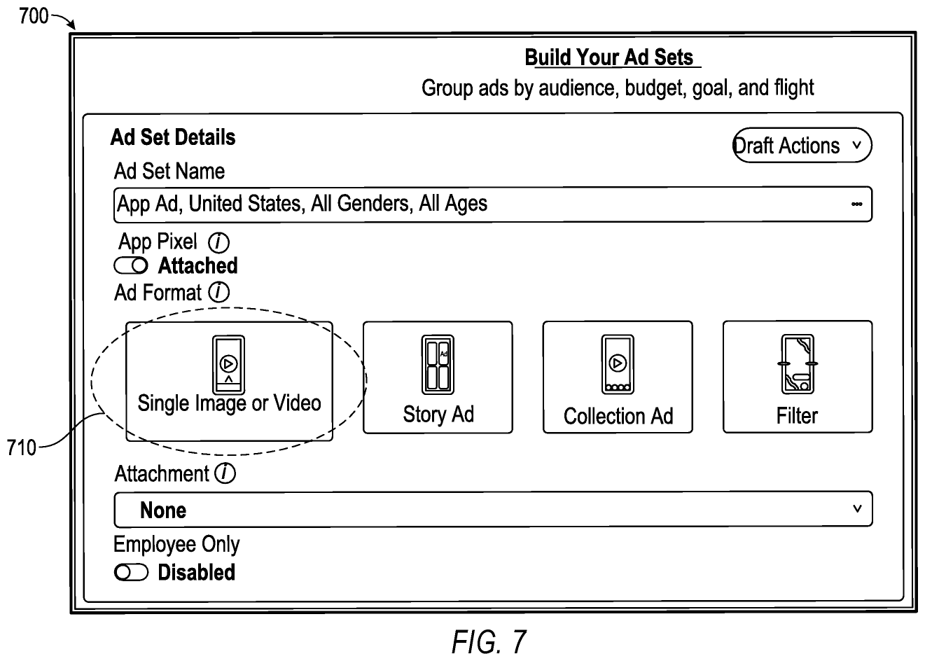

FIG. 7 illustrates a user interface 700 for selecting a format of a set of advertisements in an online advertising campaign in the subject messaging system, according to some embodiments. In an embodiment, the user interface 700 is provided by the augmented reality content generator application 124 and/or the messaging server system 108, and accessible by the client device 102 to present to a user on a display screen of the client device 102.

As shown, the user interface 700 includes various parameters (e.g., options) corresponding to respective graphical elements for selecting an objective of an online adverting campaign. In an embodiment, each advertisement set can have a single advertisement type. Some examples of advertisement types include an augmented reality content generator with an attachment, and an augmented reality content generator without an attachment. Some examples of attachments include a web link or web page (e.g., a URL accessible by the client device 102), video, image, application link (e.g., to enable the client device 102 to download and/or install), a link within an application (e.g., corresponding to a location of content provided in the application), and the like.

In an example, the user can select one or more of types of advertisements to include in the online advertising campaign using the user interface 700. As illustrated, the user has selected a graphical element 710 to indicate that the current advertisement set includes a single image or video. Examples of types of advertisements include story advertisements, collection advertisements, and filter advertisements (e.g., as shown in the user interface 700). The user interface 700 also includes an option to indicate whether the advertisement includes an attachment (e.g., as discussed above).

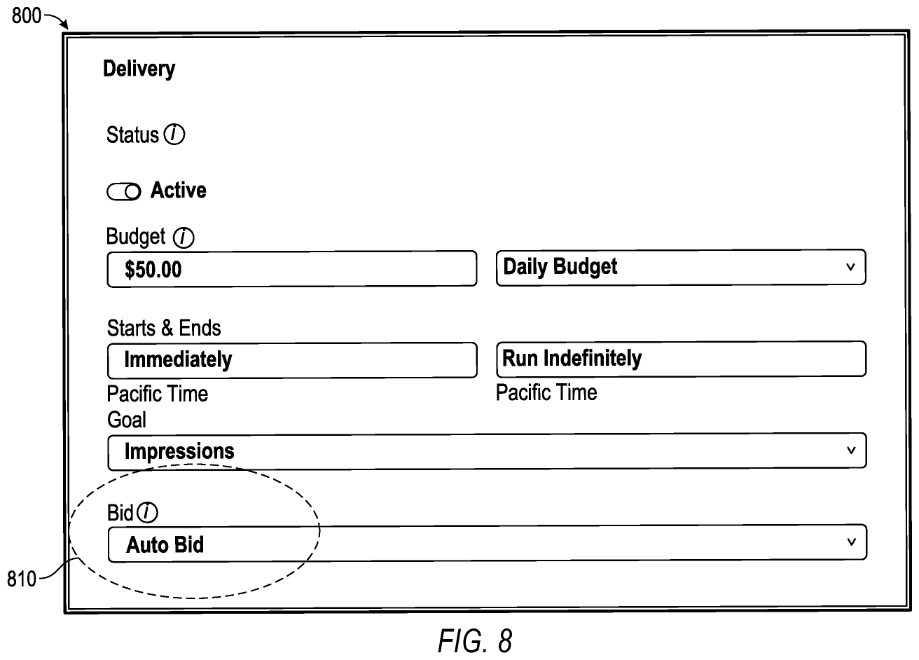

FIG. 8 illustrates a user interface 800 for setting parameters related to bidding, according to some embodiments. In an embodiment, the user interface 800 is provided by the augmented reality content generator application 124 and/or the messaging server system 108, and accessible by the client device 102 to present to a user on a display screen of the client device 102.

As shown, the user interface 800 includes graphical elements to select parameters (e.g., options) for a given advertising campaign. The user interface 800 includes an option to set a daily or lifetime budget for the advertising campaign. The user interface 800 includes an option to select the campaign objective, name, status, start and end times, and a daily and/or lifetime spending cap. In an example, a daily budget is the budget for how much to spend each day. For example: a merchant has a daily budget of $100, and the advertisement is scheduled to run from 1 PM today to 1 PM tomorrow. Since this is considered two calendar days, the merchant will have up to $100 to spend until midnight today, and an additional $100 until 1 PM tomorrow.

Based on one or more selected parameters, the subject system (e.g., the bidding module 518 and/or the pacing controller 519) monitors how the advertising campaign is delivering over the course of a day to ensure that the merchant is spending efficiently. In an example, the subject system can consider signals such as application usage, auction competition, and the advertising campaign's actual delivery in comparison to the advertising campaign's expected delivery. Based upon these signals, the subject system may reduce a merchant's bid in order to drive better value for the advertising campaign.

As further shown, the user interface 800 includes options for a type of delivery. Examples include standard delivery where standard pacing delivers the merchant's advertisement throughout the duration of the advertising campaign, and accelerated delivery where accelerated pacing spends the budget as quickly as possible without risking significant over-delivery. In an example, once the budget is reached, the subject system will stop delivery. It is appreciated that accelerated delivery can be beneficial for time-sensitive campaigns, as this configuration can deliver advertising more quickly to meet the objective(s) of the campaign.

As further shown, the user interface 800 includes options for bid types and bidding options. Examples of bid types or bidding options include impressions, uses, swipes, video views, story opens, auto bidding, maximum bid amount, and the like. As illustrated, the user has selected a graphical element 810 to select auto bidding for the advertising campaign.

In some examples, a proportional integral derivative controller (PID controller) is a control loop feedback controller sometimes used, for example, in industrial control systems. A PID controller continuously calculates an error value e(t) as the difference between a desired set-point and a measured process variable, and applies a correction based on proportional, integral, and derivative terms (sometimes denoted P, I, and D, respectively) which give their name (e.g., “PID”) to the controller type.

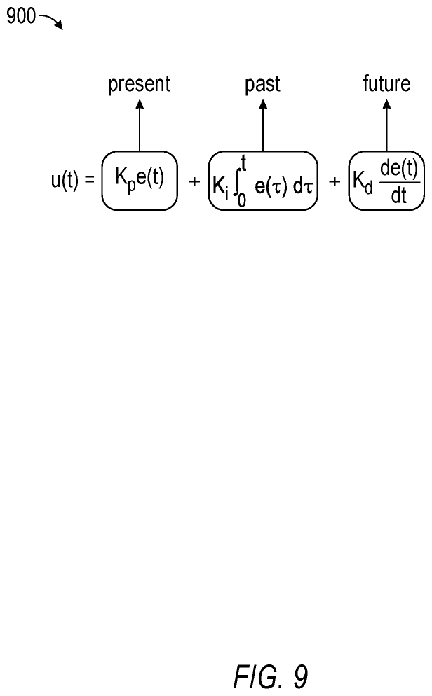

FIG. 9 illustrates an example statement representing a PID controller, in accordance with some embodiments.

As shown, an equation 900 includes values corresponding to K_p, K_i, and K_d, each of which are proportional, integral and derivative multipliers, respectively (e.g., they are constants).

In an embodiment, the following values are represented in the equation 900:
Kₚ is the proportional gain, a tuning parameter,
Kᵢ is the integral gain, a tuning parameter,
K_{d} is the derivative gain, a tuning parameter,
e(t)=SP−PV(t) is the error (SP is the setpoint, and PV(t) is the process variable),
t is the time or instantaneous time (the present),
τ is the variable of integration (takes on values from time 0 to the present),

The subject system employs improving pacing techniques that determine a global pacing multiplier Lambda (λ) per line item. In an example, a line item specifies an advertiser's commitment to purchase a specific number of impressions (e.g., cost per thousand impressions, or CPM), clicks (e.g., cost per click, or CPC), or time (e.g., cost per day, or CPD) on certain dates at a certain price. The global pacing multiplier determines whether a line item should be served less or more. Thus, increasing the global pacing multiplier results in more auction wins, which results in more tracks (e.g., impressions).

In an example, assuming that a higher global pacing multiplier correlates with more tracks, the subject system (e.g., the bidding module 518 and/or the pacing controller 519) provides a closed-loop control system to converge towards the optimal lambda given a desired rate (tracks/min). As discussed further below, global pacing multiplier is utilized to calculate a bid, and it is shown that the value of lambda correlates with more serves and tracks.

In an embodiment, examples of line items that are supported in the subject system include the following:
Share of Voice
   above all others (e.g., takeover)
Impressions
   get X number of impressions over the lifetime of the line item
Fixed CPM
   get X number of impressions over the lifetime of the line item
Daily Budget
   spend X number of dollars per day
Lifetime Budget
   spend X number of dollars between a start date and an end date of an advertising campaign (e.g., does not have to be same amount every day)
Max Reach
   get as many unique users as possible
Reach and Frequency
   get X number of impressions with Y number of unique users

In some embodiments, each line item supported by the subject system includes a goal to achieve (e.g., impressions or budget) and global pacing can achieve a smooth delivery for each line item during its lifetime. In this regard, for each line item, a respective pace of delivery is controlled using the pacing multiplier λ. In an embodiment, the pacing multiplier λ, is calculated periodically (e.g., every 20 seconds, etc.). A larger value of the pacing multiplier λ increases the serves for that line item, which increases tracks (e.g., rate or impressions per minute).

In an embodiment, operations for determining the pacing multiplier λ based on current rate (r) and desired rate (dr) are expressed as the following:
if r<dr:
   lambda=lambda*(1+scale)
else:
   lambda=lambda*(1−scale)

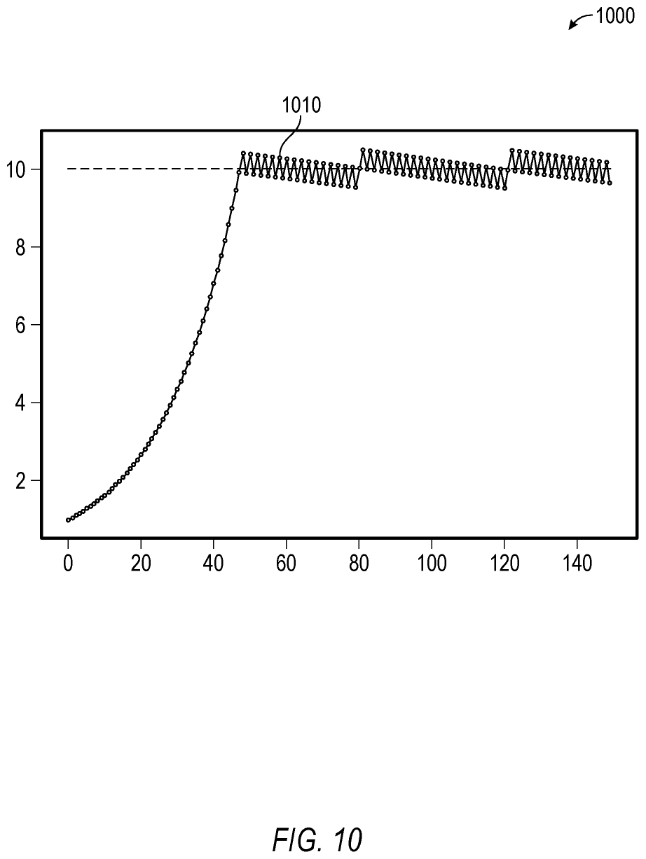

FIG. 10 illustrates an example chart 1000 of a convergence graph for a constant scale factor, in accordance with some embodiments.

As discussed further below, the constant scale factor of the convergence graph results in oscillation 1010 which can be resolved through the estimation of a fluctuation factor, which then adjusts up or down the value of the scale factor. The basic idea behind this is to move towards smaller, micro-adjustments for lambda when it appears to stabilize, while using larger magnitude updates when it appears to steadily climb or fall.

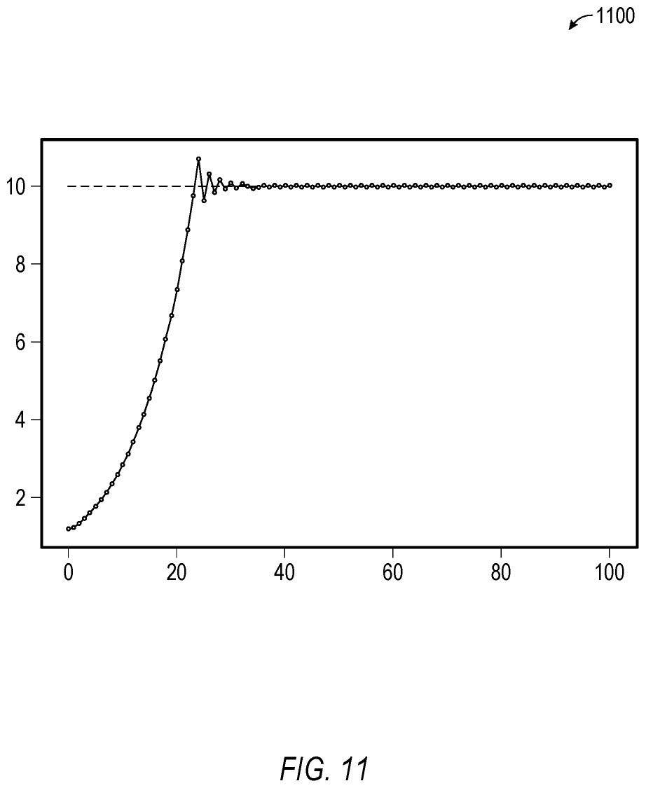

FIG. 11 illustrates an example chart 1100 with improved convergence after performing the operations based on a fluctuation factor, in accordance with some embodiments.

As shown, the chart 1100 has better convergence (e.g., indicated by an absence of oscillations) when compared to the chart 1000 discussed above after utilizing the fluctuation factor described above.

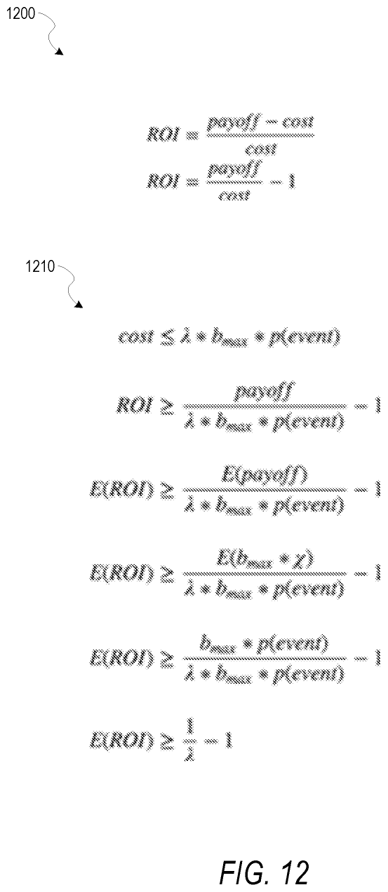

FIG. 12 illustrates example statements for determining a return on investment (ROI), in accordance with some embodiments.

In at least one embodiment, the pacing techniques described herein optimizes an advertiser's (e.g., merchant running the advertisement campaign) return on investment (ROI) by lowering their bid. In an example, an advertiser sets a bid on their advertisement with a maximum bid value (b_max). In a second price auction, it is advantageous to the advertiser if the maximum bid value reflects the true value of the advertisement. As discussed before, the pacing multiplier (lambda) attempts to reduce their bid to achieve a smooth delivery. The following discussion relates to showing that an advertiser's RIO is maximized by the disclosed techniques.

As shown, statements 1200 correspond to definitions of ROI. In a second price auction, which incentivizes bidding for the true value (and also assuming organic value>=0, which means the advertisement is not harming the user), the cost incurred to the advertiser is how much the advertiser pays for their advertiser to be shown, which is less than their bid in the auction. These relationships are expressed in statements 1210 of FIG. 12. In an example, without pacing (λ=1), the advertiser's expected ROI will be zero and as the pacing multiplier (lambda or λ) is reduced, the advertiser's ROI is increased. In this regard, if the advertiser wins the auction with a very small value of the pacing multiplier (lambda), this results in the advertiser paying much less to get the same amount of profit.

In an example, a merchant (e.g. advertiser) can create a set of advertisements (e.g., an advertisement set) that includes one or more advertisements for a given advertisement campaign. The merchant can also specify a maximum bid amount for a given line item, which corresponds to how much the merchant is willing to pay for an event (e.g., swipe, install, and the like).

An organic ad value can be estimated based on the aggregate user behavior when users are presented with an ad. The organic value can be calculated as a function of an estimate that the user will click (or “swipe”) on the advertisement, or that the user will decide to “skip” it.

Operations that determine a respective bid for a given advertisement (e.g., guaranteed impression buys, and non-guaranteed buys) can include the following:
# For guaranteed impression buys
bid=*(advertiser_value+organic_value)
# For non-guaranteed (bidded) buys
bid=(λ*advertiser_value)+organic_value

To illustrate the above, in an example, the subject system (e.g., the bidding module 518) can conduct an auction with two line items with multiple advertisements corresponding to each line item. For each advertisement, the subject system determines a bid, and the advertisement with the highest bid is chosen to participate in auction, which is demonstrated in the following:
LineItem1
   Ad1: 1.1
   Ad2: 1.2←highest bid
   Ad3: 0.9
LineItem2
   Ad1: 1.15←highest bid
   Ad2: 1.05

In the above, respective bids corresponding to LineItem1.Ad2 and LineItem2.Ad1 will participate in the auction. The bid corresponding to LineItem1.Ad2 will win the auction and the corresponding merchant will pay the price of the second highest bid (e.g., 1.15). In an embodiment, the winning merchant will pay the amount represented by:
bid(runner_up_ad)−organic_value(winner_ad)

The above statement is to address a scenario where if the advertisement has a really bad organic value and harms the user, the subject system penalizes the advertiser. Alternatively, if the advertisement is particularly relevant for the user, the subject system rewards the advertiser.

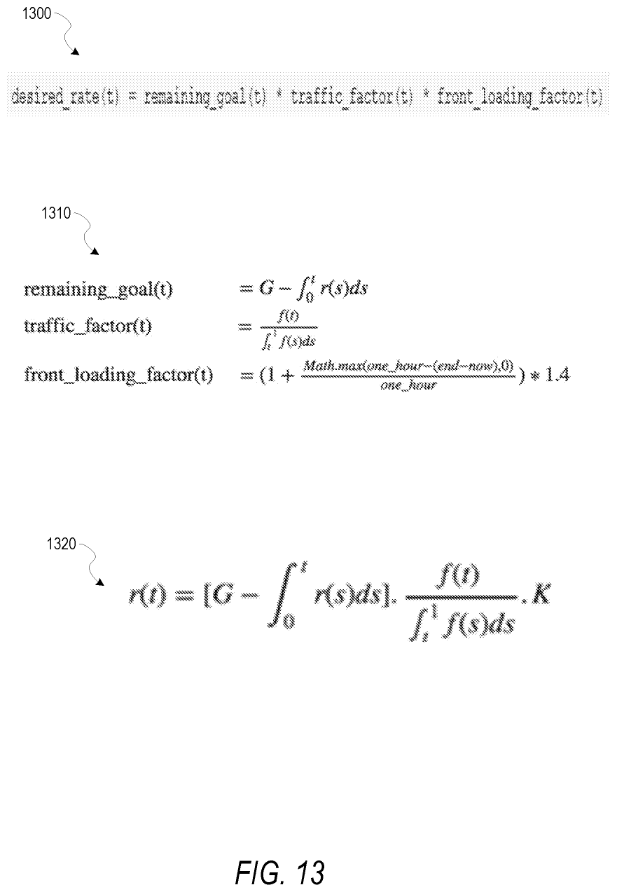

FIG. 13 illustrates example statements for determining values of desired rates for impressions, in accordance with some embodiments.

In an example, a desired rate of impressions can be a constant rate measured as goal/(end−start). However, traffic is not constant and adjustments are needed in many instances.

As shown, statement 1300 represents operations to determine a desired rate at a given point in time t. Also shown, statements 1310 includes representations of values for a remaining goal, traffic factor, and front loading factor, where goal, traffic curve, time, etc. are all normalized (e.g., between 0 and 1). In this example, the front loading factor is basically a baseline factor (e.g., 1.4 for front-loaded, 1.05 for smooth, etc.) multiplied by a multiplier which will make pacing more aggressive in the last hour of delivery. In the following discussion, the value of the front loading factor (e.g., “front_loading_factor”) is a constant value of K. As further shown, statement 1320 represents a value for a desired rate based on the statements 1310.

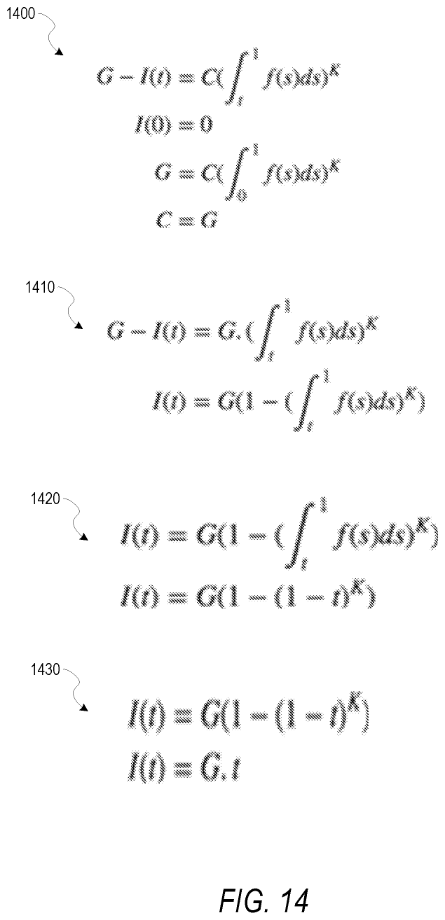

FIG. 14 illustrates example statements for determining values of desired impressions, in accordance with some embodiments.

At each point in time, it may be beneficial to determine desired impressions. As shown, statements 1400 includes operations to determine a value for a constant C. In statements 1410, I(t) represents a graph for the desired impressions, which can be determined based on the value for C. Further, statements 1420 represents a simplified desired impressions formula when a constant traffic curve is assumed. Also shown, statements 1430 represents a desired impressions formula when no front-loading (K=1) and where a line from 0 to G is observed.

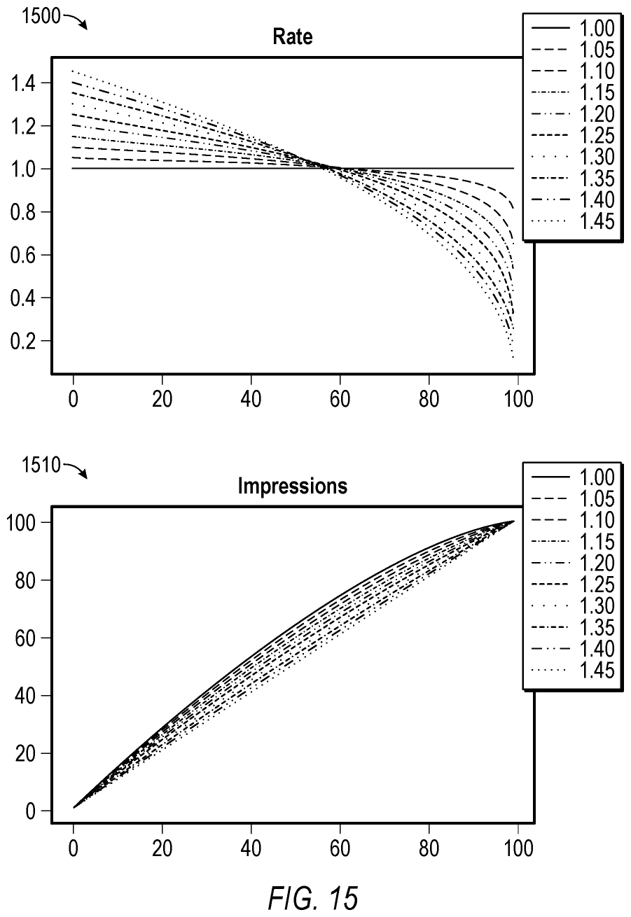

FIG. 15 illustrates example charts corresponding to rate and impression plots, in accordance with some embodiments.

In chart 1500 and chart 1510, rate and impression plots are shown for different front loading factors between 1.0 and 1.5 where the x axis represents time, and they axis represents impressions (G=100).

As discussed further herein, each line item at every point in time has a “pacing state”, which is a general indicator of performance with respect to the delivery of that line item. In an embodiment, a pacing state can be one of the below:
recently started
under pacing
nominal
over pacing
sever over pacing
hit guardrail
ending soon
reached end
reached goal
reach end of day
unknown

To determine a pacing state, the subject system (e.g., the bidding module 518 and/or the pacing controller 519) can perform the following operations.

In an embodiment, to determine the desired impressions at a current time, the subject system determines how many impressions have been received, and that ratio should be close to a value of 1. In an example, a threshold is called “ImpOverExpected” where:
UNDER_PACING: ImpOverExpected<0.9
NOMINAL: 0.9<ImpOverExpected<1.25
OVER_PACING: 1.25<ImpOverExpected<1.5
SEVERE_OVER_PACING: 1.5<ImpOverExpected

In an example, to compute a value of the threshold ImpOverExpected, the subject system determines a value of desired impressions. In an embodiment, the subject system determines the perfect impressions curve starting from a few hours ago (˜2 hours), and use that to compare with where a value of desired impressions is at a current time (e.g., now).

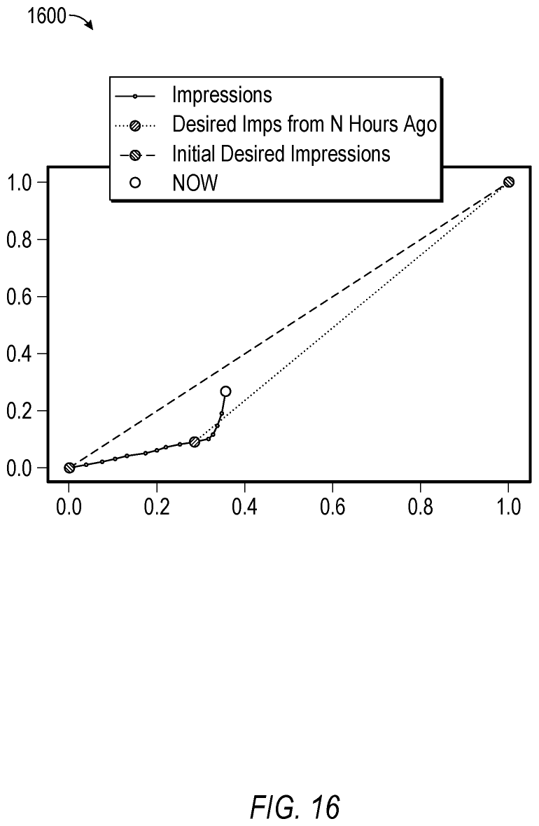

FIG. 16 includes examples of determining a value of desired impressions at a current time, in accordance with some embodiments.

As shown, chart 1600 includes a graph showing, if using the initial desired impressions, at “NOW” there would be a state of under-pacing, and while the newly calculated desired impressions, from a few hours ago, shows a state of over-pacing with respect to the newly calculated desired rate. Operations to determine the desired impressions at a current time “NOW” include the following:
def get_desired_imp(K):
   partial_curve=traffic_curve.sub_curve(start, now);
   total_curve=traffic_curve.sub_curve(start, end);
   total_int=integrate(total_curve);
   partial_int=integrate(partial_curve);
   return imp_goal*(1−pow(1−partial_int/total_int, K))

In some embodiments, the following values can be determined:
hard_deck: get_desired_imp(1.0)
expected: get_desired_imp(front_loading_factor)

In an embodiment, a value of “hard_deck” is used for logging purposes, and a value of “expected” is used to determine pacing states and for logging purposes.

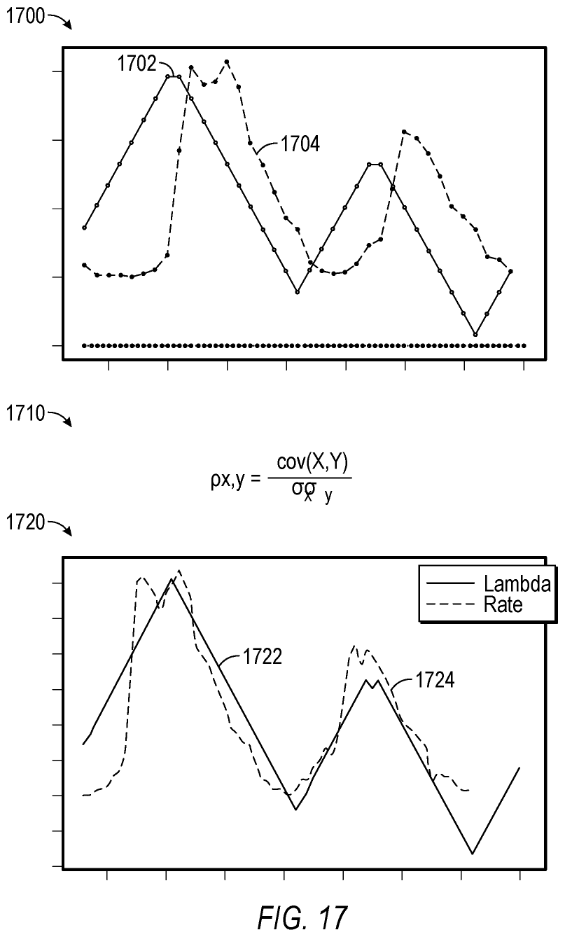

FIG. 17 includes examples of lag correction, in accordance with some embodiments.

The following discussion relates to lag correction. One potential hindrance is the lag in the feedback loop, which can cause inaccuracy and higher oscillations in the pacing techniques described herein. To implement lag correction, in an embodiment, the subject system (e.g., the bidding module 518 and/or the pacing controller 519) measures a lag L:
A more accurate way is by storing the timestamp of the pacing multiplier (lambda), and measuring a difference between a timestamp of a track (e.g., impression) and the timestamp of the pacing multiplier, and determining the average.
In another implementation, the subject system estimates a curve of the pacing multiplier (e.g., based on the last 75 samples), and a curve of rates, and determine a lag between the two curves which maximizes their correlation.
Use L to compute the next value of the pacing multiplier (lambda).
Compute the pacing multiplier (lambda) at time t, based on the comparison between rates at time t−1 and the pacing multiplier (lambda) at time t−L

As shown, chart 1700 represents an example graph of with a curve 1702 corresponding to pacing multiplier versus a curve 1704 corresponding to rates (both normalized).

In an embodiment, to compute the lag, shifting is performed for the two curves in the chart 1700 with different lags: 1, 1+E, 1+2E, . . . , MAX_LAG. A Pearson correlation coefficient is determined between the two curves, and a respective lag is chosen that maximizes the correlation. Operations to determine a Pearson correlation coefficient is represented in statement 1710. After correcting for the lag, chart 1720 shows that a curve 1722 corresponding to pacing multiplier and a curve 1724 corresponding to rates that correlate better than in chart 1700.

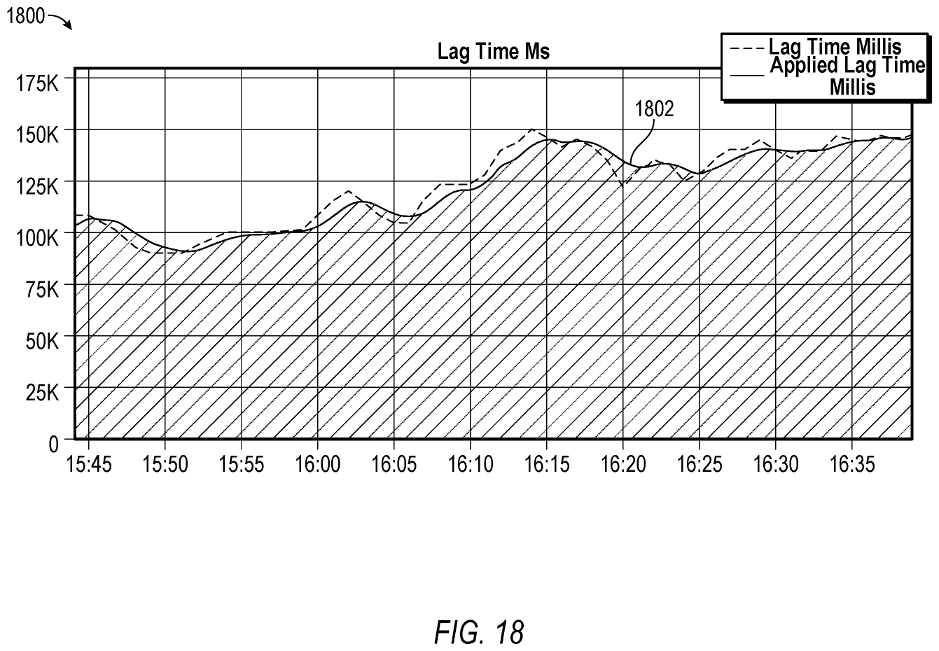

FIG. 18 illustrates an example chart of an exponential adaptation, in accordance with some embodiments.

In some embodiments, to avoid sudden jumps in the determined lag value, the subject system applies an exponential adaptation. Assuming the previous lag value was calculated as L[i], the subject system determines the current lag as NEW_LAG, and updates L[i] with the following:

L[i]=L[i−1]*k1+NEW_LAG*k2.

As shown, chart 1800 represents example results corresponding to a curve 1802 for lag times after exponential adaptation has been applied.

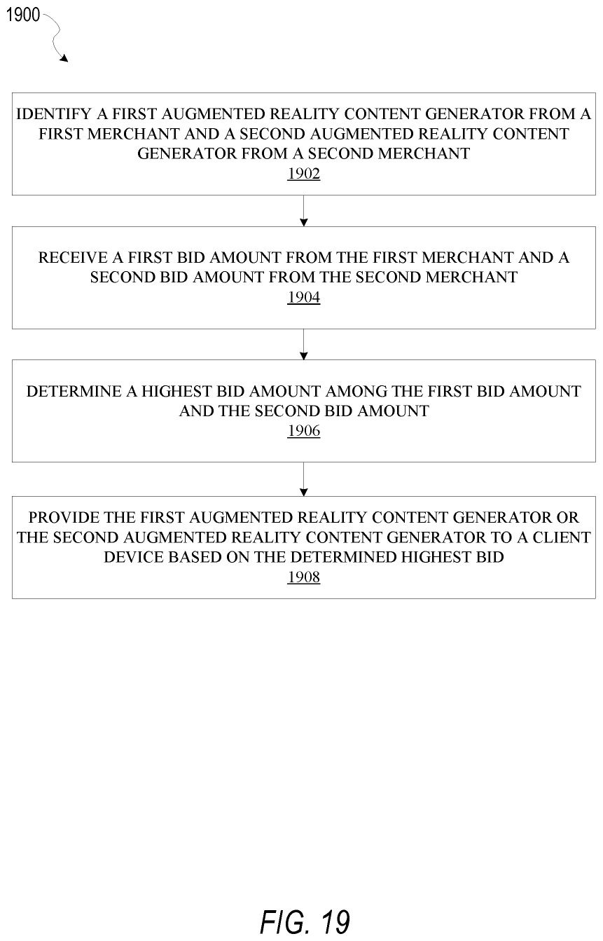

FIG. 19 is a flowchart illustrating a method to determine a highest bid in an auction based on a global pacing multiplier. The method 1900 may be embodied in computer-readable instructions for execution by one or more computer processors such that the operations of the method 1900 may be performed in part or in whole by the messaging server system 108; accordingly, the method 1900 is described below by way of example with reference thereto. However, it shall be appreciated that at least some of the operations of the method 1900 may be deployed on various other hardware configurations and the method 1900 is not intended to be limited to the messaging server system 108.

At operation 1902, the augmented reality content generator application 124 identifies a first augmented reality content generator from a first merchant and a second augmented reality content generator from a second merchant. In an example, the first merchant and the second merchant have provided or created a respective augmented reality content generator that can be then provided to a given client device (e.g., in a messaging client application 104) based on the result of an auction process described further below (and also described herein). In an example, such an auction process is a second price auction where the highest bidder pays the price bid by the second-highest bidder.

At operation 1904, the augmented reality content generator application 124 receives a first bid amount from the first merchant and a second bid amount from the second merchant, wherein the first bid amount and the second bid amount are based at least in part on a global pacing multiplier. As described before, the global pacing multiplier (e.g., lambda) is utilized to calculate a bid, and the value of lambda correlates with more serves and tracks for a given line item. In an example, each bid from each merchant is based on a monetary amount of some form.

In some embodiments, a target request is received for an electronic advertisement campaign, where the target request corresponds to a metric associated with the electronic advertisement campaign, and the electronic advertisement campaign is associated with an augmented reality content generator. The metric can correspond to a number of impressions for a period of time or a budget for the electronic advertisement campaign. A pacing value for the electronic advertisement campaign is then determined, where the pacing value corresponds to the aforementioned global pacing multiplier. As discussed before, at different points of time, or periodically, the pacing value is adjusted using a control process, such as a proportional integral derivative (PID) control process.

At operation 1906, the augmented reality content generator application 124 determines a highest bid amount among the first bid amount and the second bid amount. In an embodiment, this is accomplished through a comparison of each bid amount and determining which bid amount among all of the bid amounts is the highest bid amount.

At operation 1908, the augmented reality content generator application 124 provides the first augmented reality content generator or the second augmented reality content generator to a client device based on the determined highest bid. In an example, providing the first augmented reality content generator or the second augmented reality content generator causes a carousel interface including the first augmented reality content generator or the second augmented reality content generator to be displayed on the client device.

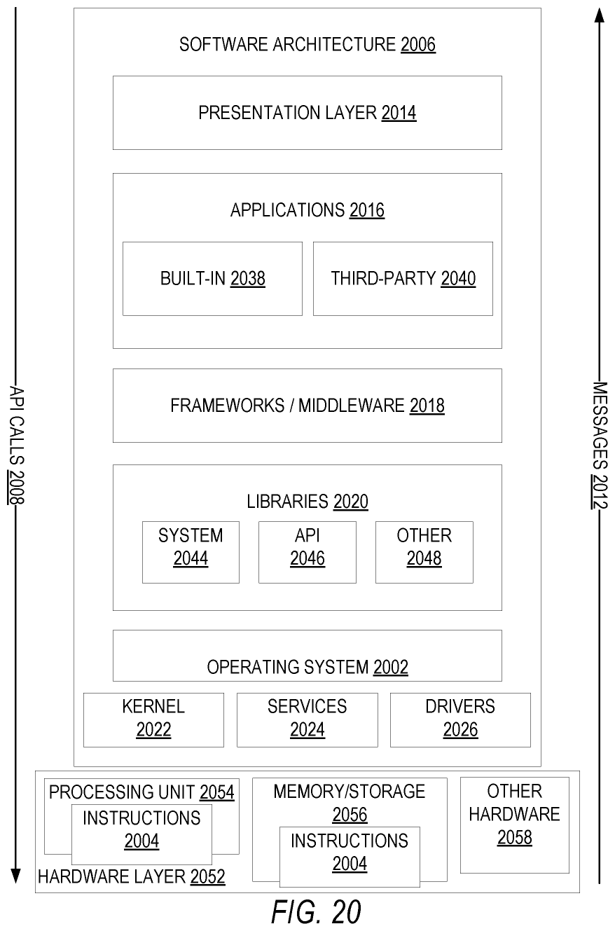

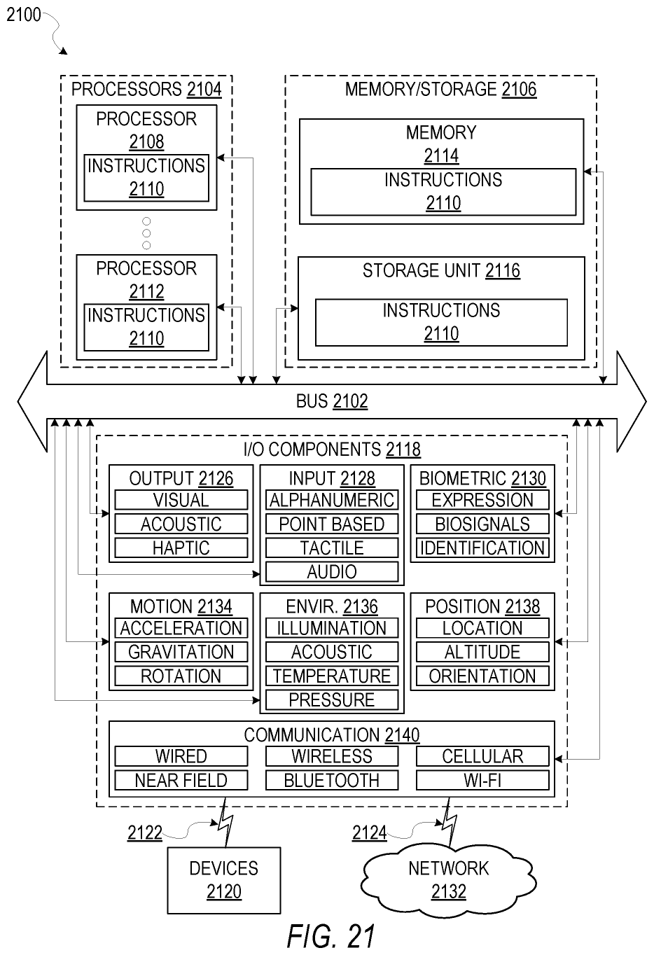

FIG. 20 is a block diagram illustrating an example software architecture 2006, which may be used in conjunction with various hardware architectures herein described. FIG. 20 is a non-limiting example of a software architecture and it will be appreciated that many other architectures may be implemented to facilitate the functionality described herein. The software architecture 2006 may execute on hardware such as machine 2100 of FIG. 21 that includes, among other things, processors 2104, memory 2114, and (input/output) I/O components 2118. A representative hardware layer 2052 is illustrated and can represent, for example, the machine 2100 of FIG. 21. The representative hardware layer 2052 includes a processing unit 2054 having associated executable instructions 2004. Executable instructions 2004 represent the executable instructions of the software architecture 2006, including implementation of the methods, components, and so forth described herein. The hardware layer 2052 also includes memory and/or storage modules memory/storage 2056, which also have executable instructions 2004. The hardware layer 2052 may also comprise other hardware 2058.

In the example architecture of FIG. 20, the software architecture 2006 may be conceptualized as a stack of layers where each layer provides particular functionality. For example, the software architecture 2006 may include layers such as an operating system 2002, libraries 2020, frameworks/middleware 2018, applications 2016, and a presentation layer 2014. Operationally, the applications 2016 and/or other components within the layers may invoke API calls 2008 through the software stack and receive messages 2012 as in response to the API calls 2008. The layers illustrated are representative in nature and not all software architectures have all layers. For example, some mobile or special purpose operating systems may not provide a frameworks/middleware 2018, while others may provide such a layer. Other software architectures may include additional or different layers.

The operating system 2002 may manage hardware resources and provide common services. The operating system 2002 may include, for example, a kernel 2022, services 2024, and drivers 2026. The kernel 2022 may act as an abstraction layer between the hardware and the other software layers. For example, the kernel 2022 may be responsible for memory management, processor management (e.g., scheduling), component management, networking, security settings, and so on. The services 2024 may provide other common services for the other software layers. The drivers 2026 are responsible for controlling or interfacing with the underlying hardware. For instance, the drivers 2026 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2020 provide a common infrastructure that is used by the applications 2016 and/or other components and/or layers. The libraries 2020 provide functionality that allows other software components to perform tasks in an easier fashion than to interface directly with the underlying operating system 2002 functionality (e.g., kernel 2022, services 2024 and/or drivers 2026). The libraries 2020 may include system libraries 2044 (e.g., C standard library) that may provide functions such as memory allocation functions, string manipulation functions, mathematical functions, and the like. In addition, the libraries 2020 may include API libraries 2046 such as media libraries (e.g., libraries to support presentation and manipulation of various media format such as MPREG4, H.204, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 2020 may also include a wide variety of other libraries 2048 to provide many other APIs to the applications 2016 and other software components/modules.

The frameworks/middleware 2018 (also sometimes referred to as middleware) provide a higher-level common infrastructure that may be used by the applications 2016 and/or other software components/modules. For example, the frameworks/middleware 2018 may provide various graphic user interface (GUI) functions, high-level resource management, high-level location services, and so forth. The frameworks/middleware 2018 may provide a broad spectrum of other APIs that may be used by the applications 2016 and/or other software components/modules, some of which may be specific to a particular operating system 2002 or platform.

The applications 2016 include built-in applications 2038 and/or third-party applications 2040. Examples of representative built-in applications 2038 may include, but are not limited to, a contacts application, a browser application, a book reader application, a location application, a media application, a messaging application, and/or a game application. Third-party applications 2040 may include an application developed using the ANDROID™ or IOS™ software development kit (SDK) by an entity other than the vendor of the particular platform, and may be mobile software running on a mobile operating system such as IOS™ ANDROID™, WINDOWS® Phone, or other mobile operating systems. The third-party applications 2040 may invoke the API calls 2008 provided by the mobile operating system (such as operating system 2002) to facilitate functionality described herein.

The applications 2016 may use built in operating system functions (e.g., kernel 2022, services 2024 and/or drivers 2026), libraries 2020, and frameworks/middleware 2018 to create user interfaces to interact with users of the system. Alternatively, or additionally, in some systems interactions with a user may occur through a presentation layer, such as presentation layer 2014. In these systems, the application/component “logic” can be separated from the aspects of the application/component that interact with a user.

FIG. 21 is a block diagram illustrating components of a machine 2100, according to some example embodiments, able to read instructions from a machine-readable medium (e.g., a machine-readable storage medium) and perform any one or more of the methodologies discussed herein. Specifically, FIG. 21 shows a diagrammatic representation of the machine 2100 in the example form of a computer system, within which instructions 2110 (e.g., software, a program, an application, an applet, an app, or other executable code) for causing the machine 2100 to perform any one or more of the methodologies discussed herein may be executed. As such, the instructions 2110 may be used to implement modules or components described herein. The instructions 2110 transform the general, non-programmed machine 2100 into a particular machine 2100 programmed to carry out the described and illustrated functions in the manner described. In alternative embodiments, the machine 2100 operates as a standalone device or may be coupled (e.g., networked) to other machines. In a networked deployment, the machine 2100 may operate in the capacity of a server machine or a client machine in a server-client network environment, or as a peer machine in a peer-to-peer (or distributed) network environment. The machine 2100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2110, sequentially or otherwise, that specify actions to be taken by machine 2100. Further, while only a single machine 2100 is illustrated, the term “machine” shall also be taken to include a collection of machines that individually or jointly execute the instructions 2110 to perform any one or more of the methodologies discussed herein.

The machine 2100 may include processors 2104, memory/storage 2106, and I/O components 2118, which may be configured to communicate with each other such as via a bus 2102. The memory/storage 2106 may include a memory 2114, such as a main memory, or other memory storage, and a storage unit 2116, both accessible to the processors 2104 such as via the bus 2102. The storage unit 2116 and memory 2114 store the instructions 2110 embodying any one or more of the methodologies or functions described herein. The instructions 2110 may also reside, completely or partially, within the memory 2114, within the storage unit 2116, within at least one of the processors 2104 such as processor 2108 or processor 2112 (e.g., within the processor's cache memory), or any suitable combination thereof, during execution thereof by the machine 2100. Accordingly, the memory 2114, the storage unit 2116, and the memory of processors 2104 are examples of machine-readable media.

The I/O components 2118 may include a wide variety of components to receive input, provide output, produce output, transmit information, exchange information, capture measurements, and so on. The specific I/O components 2118 that are included in a particular machine 2100 will depend on the type of machine. For example, portable machines such as mobile phones will likely include a touch input device or other such input mechanisms, while a headless server machine will likely not include such a touch input device. It will be appreciated that the I/O components 2118 may include many other components that are not shown in FIG. 21. The I/O components 2118 are grouped according to functionality merely for simplifying the following discussion and the grouping is in no way limiting. In various example embodiments, the I/O components 2118 may include output components 2126 and input components 2128. The output components 2126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 2118 may include biometric components 2130, motion components 2134, environmental components 2136, or position components 2138 among a wide array of other components. For example, the biometric components 2130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2134 may include acceleration sensor components (e.g., accelerometer), gravitation sensor components, rotation sensor components (e.g., gyroscope), and so forth. The environmental components 2136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2118 may include communication components 2140 operable to couple the machine 2100 to a network 2132 or devices 2120 via coupling 2124 and coupling 2122, respectively. For example, the communication components 2140 may include a network interface component or other suitable device to interface with the network 2132. In further examples, communication components 2140 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2120 may be another machine or any of a wide variety of peripheral devices (e.g., a peripheral device coupled via a USB).

Moreover, the communication components 2140 may detect identifiers or include components operable to detect identifiers. For example, the communication components 2140 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2140, such as, location via Internet Protocol (IP) geo-location, location via Wi-Fi® signal triangulation, location via detecting a NFC beacon signal that may indicate a particular location, and so forth.

As described above, augmented reality content generators, augmented reality content items, media overlays, image transformations, AR images and similar terms refer to modifications that may be made to videos or images, which may refer to respective augmented reality experiences provided by the subject technology. This includes real-time modification which modifies an image as it is captured using a device sensor and then displayed on a screen of the device with the modifications. This also includes modifications to stored content, such as video clips in a gallery that may be modified. For example, in a device with access to multiple augmented reality content generators, a user can use a single video clip with multiple augmented reality content generators to see how the different augmented reality content generators will modify the stored clip. For example, multiple augmented reality content generators that apply different pseudorandom movement models can be applied to the same content by selecting different augmented reality content generators for the content. Similarly, real-time video capture may be used with an illustrated modification to show how video images currently being captured by sensors of a device would modify the captured data. Such data may simply be displayed on the screen and not stored in memory, or the content captured by the device sensors may be recorded and stored in memory with or without the modifications (or both). In some systems, a preview feature can show how different augmented reality content generators will look within different windows in a display at the same time. This can, for example, enable multiple windows with different pseudorandom animations to be viewed on a display at the same time.

Data and various systems using augmented reality content generators or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various embodiments, different methods for achieving such transformations may be used. For example, some embodiments may involve generating a three-dimensional mesh model of the object or objects, and using transformations and animated textures of the model within the video to achieve the transformation. In other embodiments, tracking of points on an object may be used to place an image or texture (which may be two dimensional or three dimensional) at the tracked position. In still further embodiments, neural network analysis of video frames may be used to place images, models, or textures in content (e.g., images or frames of video). Augmented reality content generator data thus refers both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some embodiments, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each of element of an object are calculated (e.g., using an Active Shape Model (ASM) or other known methods). Then, a mesh based on the characteristic points is generated for each of the at least one element of the object. This mesh used in the following stage of tracking the elements of the object in the video stream. In the process of tracking, the mentioned mesh for each element is aligned with a position of each element. Then, additional points are generated on the mesh. A first set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such method, a background of the modified object can be changed or distorted as well by tracking and modifying the background.

In one or more embodiments, transformations changing some areas of an object using its elements can be performed by calculating of characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various embodiments, any combination of such modifications or other similar modifications may be used. For certain models to be animated, some characteristic points can be selected as control points to be used in determining the entire state-space of options for the model animation.

In some embodiments of a computer animation model to transform image data using face detection, the face is detected on an image with use of a specific face detection algorithm (e.g., Viola-Jones). Then, an Active Shape Model (ASM) algorithm is applied to the face region of an image to detect facial feature reference points.

In other embodiments, other methods and algorithms suitable for face detection can be used. For example, in some embodiments, features are located using a landmark which represents a distinguishable point present in most of the images under consideration. For facial landmarks, for example, the location of the left eye pupil may be used. In an initial landmark is not identifiable (e.g., if a person has an eyepatch), secondary landmarks may be used. Such landmark identification procedures may be used for any such objects. In some embodiments, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

In some embodiments, a search for landmarks from the mean shape aligned to the position and size of the face determined by a global face detector is started. Such a search then repeats the steps of suggesting a tentative shape by adjusting the locations of shape points by template matching of the image texture around each point and then conforming the tentative shape to a global shape model until convergence occurs. In some systems, individual template matches are unreliable and the shape model pools the results of the weak template matchers to form a stronger overall classifier. The entire search is repeated at each level in an image pyramid, from coarse to fine resolution.

Embodiments of a transformation system can capture an image or video stream on a client device (e.g., the client device 102) and perform complex image manipulations locally on the client device 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client device 102.

In some example embodiments, a computer animation model to transform image data can be used by a system where a user may capture an image or video stream of the user (e.g., a selfie) using a client device 102 having a neural network operating as part of a messaging client application 104 operating on the client device 102. The transform system operating within the messaging client application 104 determines the presence of a face within the image or video stream and provides modification icons associated with a computer animation model to transform image data, or the computer animation model can be present as associated with an interface described herein. The modification icons include changes which may be the basis for modifying the user's face within the image or video stream as part of the modification operation. Once a modification icon is selected, the transform system initiates a process to convert the image of the user to reflect the selected modification icon (e.g., generate a smiling face on the user). In some embodiments, a modified image or video stream may be presented in a graphical user interface displayed on the mobile client device as soon as the image or video stream is captured and a specified modification is selected. The transform system may implement a complex convolutional neural network on a portion of the image or video stream to generate and apply the selected modification. That is, the user may capture the image or video stream and be presented with a modified result in real time or near real time once a modification icon has been selected. Further, the modification may be persistent while the video stream is being captured and the selected modification icon remains toggled. Machine taught neural networks may be used to enable such modifications.

In some embodiments, the graphical user interface, presenting the modification performed by the transform system, may supply the user with additional interaction options. Such options may be based on the interface used to initiate the content capture and selection of a particular computer animation model (e.g., initiation from a content creator user interface). In various embodiments, a modification may be persistent after an initial selection of a modification icon. The user may toggle the modification on or off by tapping or otherwise selecting the face being modified by the transformation system and store it for later viewing or browse to other areas of the imaging application. Where multiple faces are modified by the transformation system, the user may toggle the modification on or off globally by tapping or selecting a single face modified and displayed within a graphical user interface. In some embodiments, individual faces, among a group of multiple faces, may be individually modified or such modifications may be individually toggled by tapping or selecting the individual face or a series of individual faces displayed within the graphical user interface.

In some example embodiments, a graphical processing pipeline architecture is provided that enables different augmented reality experiences (e.g., AR content generators) to be applied in corresponding different layers. Such a graphical processing pipeline provides an extensible rendering engine for providing multiple augmented reality experiences that are included in a composite media (e.g., image or video) for rendering by the messaging client application 104 (or the messaging system 100).

The following discussion relates to various terms or phrases that are mentioned throughout the subject disclosure.

“Signal Medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Machine-Storage Medium” refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Carrier Signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Client Device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network. In the subject disclosure, a client device is also referred to as an “electronic device.”

“Ephemeral Message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

What is claimed is:

1. A method, comprising:
identifying, using one or more hardware processors, a first augmented reality content generator from a first merchant and a second augmented reality content generator from a second merchant;
receiving, using the one or more hardware processors, a first bid amount from the first merchant and a second bid amount from the second merchant, wherein the first bid amount and the second bid amount are based at least in part on a global pacing multiplier;
determining, using the one or more hardware processors, a highest bid amount among the first bid amount and the second bid amount; and
providing, using the one or more hardware processors, the first augmented reality content generator or the second augmented reality content generator to a client device based on the determined highest bid.

2. The method of claim 1, further comprising:
determining a lower bid amount, among the first bid amount and the second bid amount, than the highest bid amount; and
excluding the first augmented reality content generator or the second augmented reality content generator, corresponding to the lower bid amount, from the client device.

3. The method of claim 1, wherein the first bid amount is unknown to the second merchant and the second bid amount is unknown to the first merchant.

4. The method of claim 2, wherein the lower bid amount corresponds to a final bid amount associated with the first augmented reality content generator or the second augmented reality content generator that is provided to the client device.

5. The method of claim 1, wherein providing the first augmented reality content generator or the second augmented reality content generator comprises:
causing a carousel interface including the first augmented reality content generator or the second augmented reality content generator to be displayed on the client device.

6. The method of claim 1, further comprising:
receiving a target request for an electronic advertisement campaign, the target request corresponding to a metric associated with the electronic advertisement campaign, the electronic advertisement campaign associated with an augmented reality content generator.

7. The method of claim 6, wherein the metric comprises a number of impressions for a period of time or a budget for the electronic advertisement campaign.

8. The method of claim 6, further comprising:
determining a pacing value for the electronic advertisement campaign, the pacing value corresponding to the global pacing multiplier.

9. The method of claim 8, further comprising:
adjusting the pacing value using a control process.

10. The method of claim 9, wherein the control process comprises a proportional integral derivative (PID) control process.

11. A system comprising:
a processor; and
a memory including instructions that, when executed by the processor, cause the processor to perform operations comprising:
identifying, using one or more hardware processors, a first augmented reality content generator from a first merchant and a second augmented reality content generator from a second merchant;
receiving, using the one or more hardware processors, a first bid amount from the first merchant and a second bid amount from the second merchant, wherein the first bid amount and the second bid amount are based at least in part on a global pacing multiplier;
determining, using the one or more hardware processors, a highest bid amount among the first bid amount and the second bid amount; and
providing, using the one or more hardware processors, the first augmented reality content generator or the second augmented reality content generator to a client device based on the determined highest bid.

12. The system of claim 11, wherein the memory includes further instructions, which further cause the processor to perform further operations comprising:
determining a lower bid amount, among the first bid amount and the second bid amount, than the highest bid amount; and
excluding the first augmented reality content generator or the second augmented reality content generator, corresponding to the lower bid amount, from the client device.

13. The system of claim 11, wherein the first bid amount is unknown to the second merchant and the second bid amount is unknown to the first merchant.

14. The system of claim 12, wherein the lower bid amount corresponds to a final bid amount associated with the first augmented reality content generator or the second augmented reality content generator that is provided to the client device.

15. The system of claim 11, wherein providing the first augmented reality content generator or the second augmented reality content generator comprises:
causing a carousel interface including the first augmented reality content generator or the second augmented reality content generator to be displayed on the client device.

16. The system of claim 11, wherein the memory includes further instructions, which further cause the processor to perform further operations comprising:
receiving a target request for an electronic advertisement campaign, the target request corresponding to a metric associated with the electronic advertisement campaign, the electronic advertisement campaign associated with an augmented reality content generator.

17. The system of claim 16, wherein the metric comprises a number of impressions for a period of time or a budget for the electronic advertisement campaign.

18. The system of claim 16, wherein the memory includes further instructions, which further cause the processor to perform further operations comprising:
determining a pacing value for the electronic advertisement campaign, the pacing value corresponding to the global pacing multiplier.

19. The system of claim 18, wherein the memory includes further instructions, which further cause the processor to perform further operations comprising:
adjusting the pacing value using a control process.

20. A non-transitory computer-readable medium comprising instructions, which when executed by a computing device, cause the computing device to perform operations comprising:
identifying a first augmented reality content generator from a first merchant and a second augmented reality content generator from a second merchant;
receiving a first bid amount from the first merchant and a second bid amount from the second merchant, wherein the first bid amount and the second bid amount are based at least in part on a global pacing multiplier;
determining a highest bid amount among the first bid amount and the second bid amount; and
providing the first augmented reality content generator or the second augmented reality content generator to a client device based on the determined highest bid.
